(19) United States
(12) Patent Application Publication
(10) Pub. No.: US 2016/0071141 A1
(43) Pub. Date: Mar. 10, 2016

(54) DEFERRED LOYALTY POINTS REDEMPTION METHOD

(71) Applicant: III Holdings 1, LLC, WILMINGTON, DE (US)

(72) Inventors: Trey Neemann, Glendale, AZ (US); Raymond K. Preston, Peoria, AZ (US)

(21) Appl. No.: 14/853,560

(22) Filed: Sep. 14, 2015

Related U.S. Application Data
(63) Continuation of application No. 10/882,815, filed on Jul. 1, 2004, now abandoned.

(51) Int. Cl. G06Q 30/02

(52) U.S. Cl. CPC G06Q 30/0227; G06Q 30/0233

(57) ABSTRACT

On-line redemption of loyalty points over time for requested items. A request for an item is received from a customer along with an identification of a layaway program for redeeming at least a portion of the customer's loyalty points with respect to a purchase request for the item. Based upon the identified program, the customer's loyalty points are processed for redemption. The redemption programs can include making installment payments of loyalty points for purchase of the item, reserving a particular price for the item using the loyalty points, providing partial payment for the item using the loyalty points, automatically redeeming or transferring points over a particular amount, or pooling of points among multiple customers.

The present application is a continuation of U.S. application Ser. No. 10/882,815, filed Jul. 1, 2004, the disclosure of which is incorporated by reference herein in its entirety.

### FIELD OF INVENTION

The present invention relates to an apparatus and method for facilitating the deferred redemption of loyalty points or other incentives.

### BACKGROUND OF THE INVENTION

Many loyalty programs are comparable in that all the points needed for the redemption must be available in advance. These points may have been earned in the past or obtained through some function which adds points to the balance (such as buying or reinstating lost points, or transferring points from another loyalty account), but a sufficient balance must still be available for the transaction to proceed.

In the physical world, some retail merchants offer their customers the ability to purchase products through “layaway” programs. For these programs, the customer does not take possession of the selected product until it is completely paid for by the customer. Following some nominal initial payment by the customer, the product is held by the merchant, but out of inventory so that no other customer can acquire it. The buying customer then typically completes periodic payments on the product. Once the product is paid in full, the customer may take possession of the product. Typically the customer is allotted a fixed period of time to complete the full payment for the item or else the item is returned to inventory and some portion of the accrued payment is refunded to the customer.

A layaway program may also include a customer providing an initial payment on a product in order to “lock in” (or guarantee) the price of that product. For example, if an item is available at a discount or a sale price, that price is usually available only for a specific period of time. When that period is over, the price of that item returns to its original price or becomes unavailable. By making a nominal payment during the sale period, the customer reserves the right to pay the sale price for the product, regardless of when it is actually bought.

Another approach to providing products to customers where the actual transaction is extended over time is when a customer “reserves” a product for a designated price. This approach differs from the previous program in that there is no price surety, but there is a guarantee of product availability for the customer. This particular approach may be useful for limited supply rewards that the customer desires to redeem. Another interesting difference is that the reward being “reserved” may not actually be publicly available yet. As such, the customer may indicate in advance their intent to acquire the reward once it becomes available.

Yet another approach is through a sweepstakes program possibly including automatic redemption. After a customer has accumulated a particular number of loyalty points, any additional points issued to the customer may be automatically transferred or redeemed. For example, the additional points may be redeemed for a credit issued to the customer using any known financial products (e.g., account credit, gift card, coupon, etc.).

Currently, most on-line retail shopping sites require the complete payment for purchases, where the products must be paid for completely (in-full) by the customers. Some sites may even provide installment payments for the selected product, where the product is completely paid over time. However, in each case, the product is typically delivered immediately to the customer. The difference is in the timing of the payment for the product.

Moreover, on-line retailers have often pushed the ability to buy a product over time onto credit service organizations by encouraging customers to use existing installment billing mechanisms. The use of credit service organizations insulate the retailer from the extended payment window because a single transaction exists for the retailer, yet the credit service organization manages the extended payments. Additionally, the use of credit service organizations minimizes the inventory management issues that can arise from holding product that is partially paid for by the customer. Helping to maintain outstanding loyalty points to a minimum also benefits the merchants.

Accordingly, a need exists for programs to redeem loyalty points in order, for example, to reduce overhead in terms of liabilities for merchants by in part reducing their requirements to hold inventory associated with the loyalty points.

### SUMMARY OF THE INVENTION

The invention includes an improved system and method for redeeming loyalty points over time. The system receives from a customer a request for an item along with an identification of a layaway program for redeeming at least a portion of the customer's loyalty points with respect to a purchase request for the item. Based upon the identified program, the customer's loyalty points are processed for redemption. The layaway programs may include, for example, the customer's loyalty points used in a series of installments in order to purchase the item, a reserve reward program in which the customer's loyalty points are used to reserve a particular price for the item and a pay program in which the customer's loyalty points are used for a portion of the price to purchase the item.

### BRIEF DESCRIPTION OF THE DRAWINGS

The accompanying drawings, wherein like reference numerals represent like elements, are incorporated in and constitute a part of this specification and, together with the description, explain the advantages and principles of the invention. In the drawings,

FIG. 1 is a diagram of an exemplary system for processing redemption programs using loyalty points;

FIG. 2 is a diagram of exemplary components of a system for executing the present invention;

FIGS. 3-6 are a flow chart of an exemplary method for redeeming points for items according to various redemption programs; and

FIG. 7 is a diagram of a screen for a customer to select a redemption program for an item.

### DETAILED DESCRIPTION

Introduction

The invention generally includes a method and system for facilitating the redemption of loyalty points over a period of time. The customer may send a request for an item along with an identification of a layaway program for redeeming at least a portion of the customer's loyalty points with respect to a purchase request for the item. Based upon the identified program, the system may process the customer's loyalty points for redemption. The layaway programs may include, for example, the customer's loyalty points used in a series of installments in order to purchase the item, a reserve reward program in which the customer's loyalty points are used to reserve a particular price for the item and a pay program in which the customer's loyalty points are used for a portion of the price to purchase the item.

Reward, as used herein, may include any good, service, package, event, experience (e.g., hot air ballooning over the desert, dining with a famous sports star, etc) or any other item. Moreover, the redemption may include obtaining a reward using any portion of points, coupons, cash, foreign currency, gift, negotiable instruments, securities and/or the like. As used herein, “transmit” may include sending electronic data from one system component to another over a network connection. Additionally, as used herein, “data” may include encompassing information such as commands, queries, files, data for storage, and the like in digital or any other form.

In one embodiment, a layaway program may include a reward which is paid for over time, wherein succeeding point payments are made from a customer or a customer account until the redemption is complete. When the redemption transaction is initiated, the number of points available to the customer is compared with the points required for the reward. If there are not enough points available, the customer may not immediately redeem points for that reward. If they choose to, the customer could elect to use some or all of their current points as a “deposit” and place the reward into layaway. The active inventory level for the reward may be reduced and the layaway inventory may be increased. A separate record of the request may be posted along with a history of the deposit/payment history for the redemption. Periodically, the customer may be able to take any points available in their loyalty account and apply them to the “held” redemption as a payment. Once the full amount of the reward has been paid, the loyalty program removes the item from inventory and requests the partner (who may control the reward item) to send the reward to the customer. The layaway program may be offered to the customer as a standard (free) feature of the program (to encourage partial redemptions) or it may assess a usage surcharge such as a nominal cash fee or a point premium. The surcharge may be applied as the reward is placed into the layaway state.

In another embodiment, a Reward Cost Guarantee may allow customers to “guarantee” a reward at a particular price or a price range. The customer may complete an initial point “deposit” for the reward which may place the reward in the layaway program. The “guarantee” would not necessarily require a fee or premium, but may not allow the customer to cancel the request. Once initiated, any points applied to the reward may be non-refundable to the customer. This approach may be used if the loyalty program started offering reward “specials,” where a particular reward could be redeemed for a discounted number of points for a short period of time.

In another embodiment, a Reserve a Reward system may allow customers to “reserve” a reward. An immediate point “deposit” may not be required, but the system may require a customer action within a designated period of time. In other words, the customer may reserve the reward for seven days, for example, from the current or first date the reward is available (whichever is later). If after that seven-day period the redemption has not been completed, the customer may forfeit their claim to the reward and that reward may be returned to the inventory. The redemption transaction itself may not occur over time, rather, it may be fully processed using known in the art redemption processing methods. However, the reward may be “held” out of general inventory for the customer.

The reserve a reward embodiment may be beneficial when, for example, a loyalty program starts to “advertise” new reward offerings before the offerings actually become available. For example, if a new product will be available for redemption next month, customers may then signal their interest and intent by reserving one of these new rewards before the rewards can be redeemed. In another embodiment, if limited inventory for a reward exists, a customer may insure that he has access to one of these rewards by reserving a reward. For example, there may be 100 limited rewards being offered, but the customer may not have enough points at the moment, so the customer may reserve one of the rewards.

Another program involves the automatic redemption and/or automatic transfer of loyalty points. After a customer has accumulated a particular number of loyalty points, any additional points issued to the customer may be automatically transferred or redeemed. For example, the additional points may be redeemed for a cash value and transferred into a mutual fund or can be redeemed for a credit issued to the customer using any known financial products (e.g., account credit, gift card, coupon, etc.).

One way to increase points available for redemption involves pooling, in which multiple customers may combine or “pool” their loyalty points and then share in an item obtained by redeeming the pooled points. For example, several customers may combine their points and then redeem them for concert tickets to be shared by the customers.

Since rewards may not be “held” indefinitely, each layaway request may include an expiration date. If the redemption is not completed before the expiration date, the reward that has been placed into layaway may be canceled by the program (involuntary cancellation). The involuntary cancellation may be handled similarly to a standard redemption that is canceled, wherein the reward is returned to the active inventory and any points that have been used to date for the redemption are returned to the loyalty account, subject to any penalty that may be enforced.

In addition to, or instead of, a usage fee, the program may enforce a penalty charge if the layaway redemption is canceled in some way (either voluntarily by the customer or involuntarily by the program when the redemption is not completed by the expiration date). Like with the surcharge, the penalty may be assessed as either a cash fee or as a point charge.

Once the reward has been placed into layaway, the customer may complete the redemption through, for example, periodic requests from the customer similar to a standard redemption. As the customer obtains more points or the points otherwise become available, the customer may apply those points to their in-process redemption. A defined schedule of when points may be applied to the in-process redemption is not required, as the customer may simply use their available points against the in-process redemption.

In another embodiment, the redemption may be completed through automatic point payments when the points are made available to the loyalty account. After the points are added to the loyalty account, the points may be automatically deducted for the in-process redemption. The deduction may continue until the reward is completely “paid for” at which time the system initiates the process for the reward to be shipped to the customer. This is more of a scheduled approach where points are consumed for the in-process redemption as they are added to the account. As an alternative to deductions from a single customer's account, the deductions may occur across multiple customers pooling their accounts for an item or reward.

In another embodiment, the redemption may be completed by allowing the customer to designate the number of new points to be allocated to the in-process redemption. As the points are made available to the loyalty account, the designated number of points may only be applied to the “in process” redemption. This process may allow for excess points to be used for other redemptions and ultimately may provide the customer greater control over what points are actually being used. This approach also may follow a schedule wherein it allows the customer to indicate the points to be used for the redemption payment. Also, this approach may include a “sweep” ability, meaning the automatic transfer or redemption of points, to automatically transfer loyalty points after reaching a predetermined or particular threshold number of points.

The reward may be placed into layaway for the customer at several different times. The reward may be placed into layaway as a choice by the customer. For example, even though the customer may have adequate points available, the customer may prefer to complete the redemption over time. In another embodiment, as the customer starts the redemption transaction and has too many items for their current point balance, the customer may elect to place some of the rewards into the lay away program. Since the timing of placing the reward into the program can vary, the amount of related data can vary for each instance. For example, some rewards may have the associated delivery data present where others may not have delivery data. Because a time lag may exist between when the reward was selected and the transaction is actually completed, any delivery address information previously collected may not be utilized. Rather, the loyalty program may deliver the reward to the default delivery address for the loyalty account.

The invention may provide the customer with more chances to use their accumulated loyalty points. Although the invention requires that the reward be taken out of inventory, the overall point liability reserve required by the company is reduced. Moreover, fees or premiums may be assessed the customer which is incremental revenue to the loyalty company. A point surcharge or a nominal fee may be applied to remove a reward from the inventory. This surcharge or fee may be non-refundable if the customer releases the “held” reward back to the inventory and their purchased points are returned. Furthermore, because the invention provides the appearance that rewards are more available since redemptions can begin sooner, the invention may drive increased spend by those customers that would use the functionality. Additionally, because a customer may have partially redeemed for a reward (and they cannot get that reward until its completely redeemed), additional motivation exists to earn the points needed to complete the redemption.

Network Environment

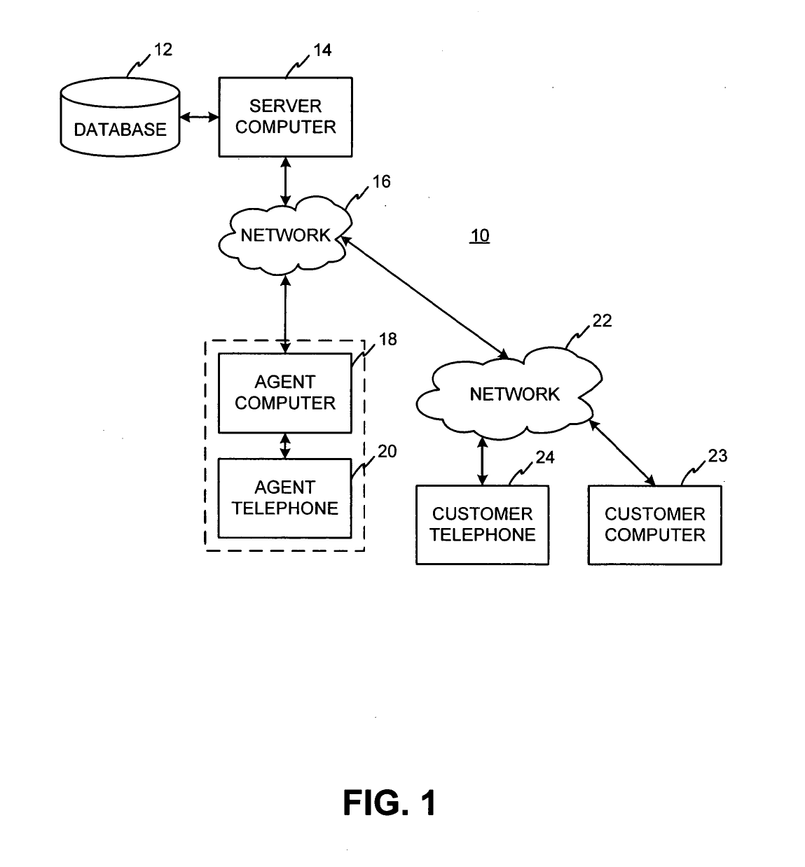

An exemplary system 10 for processing requests for redemption of loyalty points to process purchase requests is shown in FIG. 1. System 10 includes, in one embodiment, an agent computer 18 having a connection via a network 16 with a server computer 14. Agent computer 18 also includes an associated agent telephone or other communication device 20. System 10 includes a customer telephone or other communication device 24, along with a customer computer 23, for a customer to contact an agent at agent telephone 20, or computer 18, via a network 22, if necessary or desired. System 10 may use server 14 to maintain a web site in order to programmatically process redemption programs. The agent computer and telephone can be used in one embodiment where the system may provide telephone customer support of other services, for example.

While the system and method of the present invention may apply to telephone or network communications, one skilled in the art will appreciate that the present invention may be implemented with other types of communications. Networks 16 and 22 can include any wireline or wireless network for data transmission discussed herein such as, for example, a Transmission Control Protocol/Internet Protocol (TCP/IP) network. For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical electronic transaction system.

The system may include a host server or other computing systems (e.g., at server computer 14, agent computer 18, customer telephone or other communication device 24, or customer computer 23) including a processor for processing digital data, a memory coupled to said processor for storing digital data, an input digitizer coupled to the processor for inputting digital data, an application program stored in said memory and accessible by said processor for directing processing of digital data by said processor, a display coupled to the processor and memory for displaying information derived from digital data processed by said processor and a plurality of databases, said databases including client data, merchant data, financial institution data and/or like data that could be used in association with the present invention. As those skilled in the art will appreciate, customer computer will typically include an operating system (e.g., Windows NT, 95/98/2000, Linux, Solaris, etc.) as well as various conventional support software and drivers typically associated with computers. Customer computer can be in a home or business environment with access to a network. In an exemplary embodiment, access is through the Internet through a commercially-available web-browser software package.

Communication between the parties to the transaction (e.g., network 22) and the system (e.g., network 16) of the present invention may be accomplished through any suitable communication means, such as, for example, a telephone network, Intranet, Internet, point of interaction device (point of sale device, personal digital assistant, cellular phone, kiosk, etc.), on-line communications, off-line communications, wireless communications, transponder communications and/or the like. One skilled in the art will also appreciate that, for security reasons, any databases, systems, or components of the present invention may include any combination of databases or components at a single location or at multiple locations, wherein each database or system includes any of various suitable security features, such as firewalls, access codes, encryption, decryption, compression, decompression, and/or the like.

As described herein, the computing units may be connected with each other via a data communication network. The network may be a public network and assumed to be insecure and open to eavesdroppers. The network may be embodied as the internet. In this context, the computers may or may not be connected to the internet at all times. For instance, the customer computer may employ a modem to occasionally connect to the internet, whereas the computer may maintain a permanent connection to the intemet. Specific information related to the protocols, standards, and application software utilized in connection with the Internet may not be discussed herein. For further information regarding such details, see, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997). LOSHIN, TCP/IP CLEARLY EXPLAINED (1997). All of these texts are hereby incorporated by reference.

The systems may be suitably coupled to the networks via data links. A variety of conventional communications media and protocols may be used for data links. Such as, for example, a connection to an Internet Service Provider (ISP) over the local loop as is typically used in connection with standard modem communication, cable modem, Dish networks, ISDN, Digital Subscriber Line (DSL), or various wireless communication methods. The system might also reside within a local area network (LAN) which interfaces to network via a leased line (T1, D3, etc.). Such communication methods are well known in the art, and are covered in a variety of standard texts. See, e.g., GILBERT HELD, UNDERSTANDING DATA COMMUNICATIONS (1996), hereby incorporated by reference.

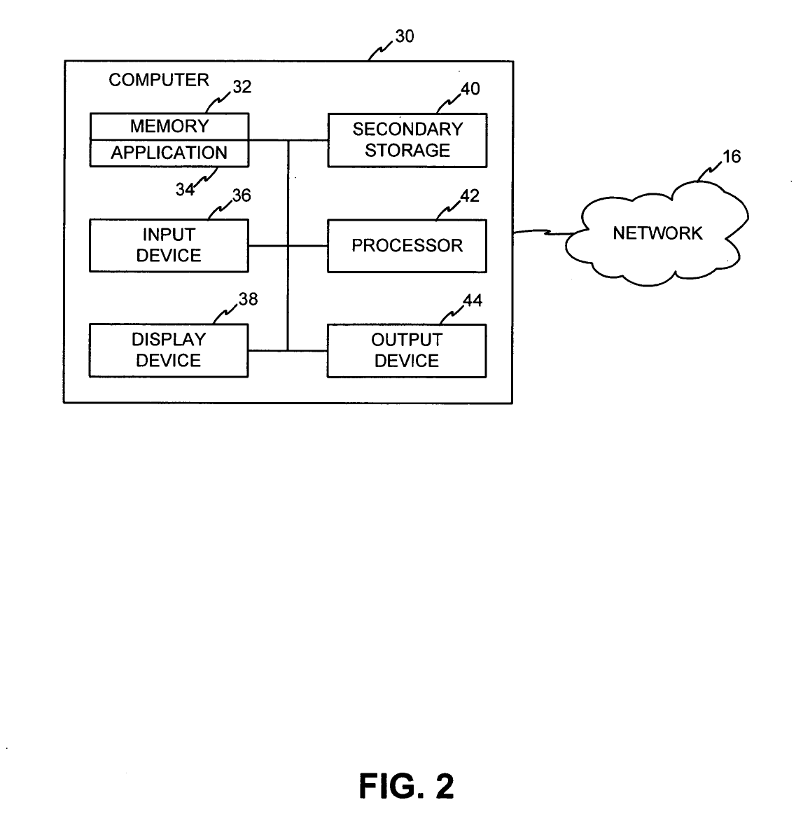

FIG. 2 is a diagram of a exemplary computer 30 illustrating typical components of server computer 14 and agent computer 18. Computer 30 can include a connection with network 16 such as the Internet through any suitable network connection. Computer 30 typically includes a memory 32, a secondary storage device 40, a processor 42, an input device 36 for entering information into computer 30, a display device 38 for providing a visual display of information, and an output device 44 for outputting information such as in hard copy or audio form. Memory 32 may include random access memory (RAM) or similar types of memory, and it may store one or more applications 34 for execution by processor 42.

Secondary storage device 40 may include a hard disk drive, floppy disk drive, CD-ROM drive, or other types of non-volatile data storage. Processor 42 may execute applications or programs stored in memory 34 or secondary storage 40, or received from the Internet or other network 16. Although computer 30 is depicted with various components, one skilled in the art will appreciate that the server and agent computers can contain different components.

The computers discussed herein may provide a suitable web site or other Internet-based graphical customer interface which is accessible by customers. In one embodiment, the Internet Information Server, Microsoft Transaction Server, and Microsoft SQL Server, are used in conjunction with the Microsoft operating system, Microsoft NT web server software, a Microsoft SQL database system, and a Microsoft Commerce Server. Additionally, components such as Access or SQL Server, Oracle, Sybase, Informix MySQL, Interbase, etc., may be used to provide an ADO-compliant database management system.

Any of the communications, inputs, storage, databases or displays discussed herein may be facilitated through a web site having webpages. The term “webpage” as it is used herein is not meant to limit the type of documents and applications that might be used to interact with the customer. For example, a typical web site might include, in addition to standard HTML documents, various forms, Java applets, Javascript, active server pages (ASP), common gateway interface scripts (CGI), extensible markup language (XML), dynamic HTML, cascading style sheets (CSS), helper applications, plug-ins, and the like. A server may include a webservice which receives a request from a browser which includes a URL (http://yahoo.com/stockquotes/ge) and an IP address (123.56.789). The webservice retrieves the appropriate webpages and sends the webpages to the IP address.

It will be appreciated that many applications of the present invention could be formulated. One skilled in the art will appreciate that the network may include any system for exchanging data or transacting business, such as the Internet, an intranet, an extranet, WAN, LAN, satellite communications, and/or the like. It is noted that the network may be implemented as other types of networks, such as an interactive television (ITV) network. The parties may interact with the system via any input device such as a keyboard, mouse, kiosk, personal digital assistant, handheld computer (e.g., Palm Pilot®), cellular phone and/or any suitable communication or data input modality; other types of input devices include pervasive computer devices such as, for example, a kitchen appliance, jewelry, or a financial instrument. Similarly, the invention could be used in conjunction with any suitable personal computer, network computer, workstation, minicomputer, mainframe, or the like running any operating system such as any version of Windows, Windows NT, Windows2000, Windows 98, Windows 95, MacOS, OS/2, BeOS, Linux, UNIX, Solaris or the like. Moreover, although the invention is frequently described herein as being implemented with TCP/IP communications protocols, the invention may also be implemented using IPX, Appletalk, IP-6, NetBIOS, OSI or any number of existing or future protocols. Moreover, the system contemplates the use, sale or distribution of any goods, services or information over any network having similar functionality described herein.

Loyalty Points Deferred Redemption Methods

The present invention may be described herein in terms of functional block components, optional selections and various processing steps. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Java, COBOL, assembler, PERL, Visual Basic, SQL Stored Procedures, extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like. Still further, the invention could be used to detect or prevent security issues with a client-side scripting language, such as JavaScript, VBScript or the like. For a basic introduction of cryptography and network security, the following may be helpful references: (1) “Applied Cryptography: Protocols, Algorithms, And Source Code In C,” by Bruce Schneier, published by John Wiley & Sons (second edition, 1996); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

As will be appreciated by one of ordinary skill in the art, the present invention may be embodied as a method, a data processing system, a device for data processing, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The present invention is described herein with reference to screen shots, block diagrams and flow chart illustrations of methods, apparatus (e.g., systems), and computer program products according to various aspects of the invention. It will be understood that each functional block of the block diagrams and the flow chart illustrations, and combinations of functional blocks in the block diagrams and flow chart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flow chart block or blocks.

These computer program instructions may also be stored in a computer-readable memory that can direct a computer or other programmable data processing apparatus to function in a particular manner, such that the instructions stored in the computer-readable memory produce a module or an article of manufacture including instruction means which implement the function specified in the flow chart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flow chart block or blocks.

Accordingly, functional blocks of the block diagrams and flow chart illustrations support combinations of means for performing the specified functions, combinations of steps for performing the specified functions, and program instruction means for performing the specified functions. It will also be understood that each functional block of the block diagrams and flow chart illustrations, and combinations of functional blocks in the block diagrams and flow chart illustrations, can be implemented by either special purpose hardware-based computer systems which perform the specified functions or steps, or suitable combinations of special purpose hardware and computer instructions.

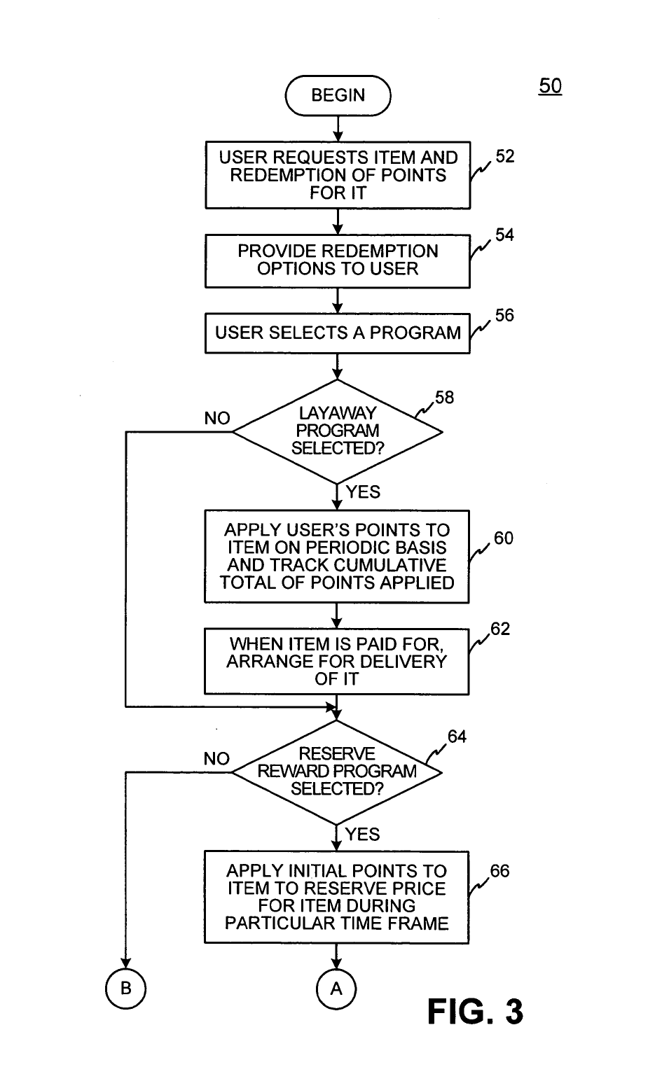

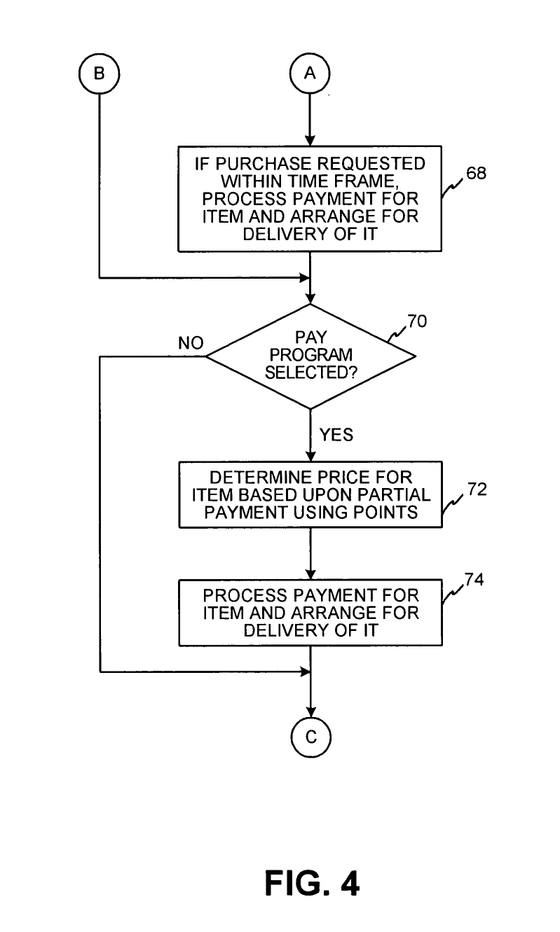

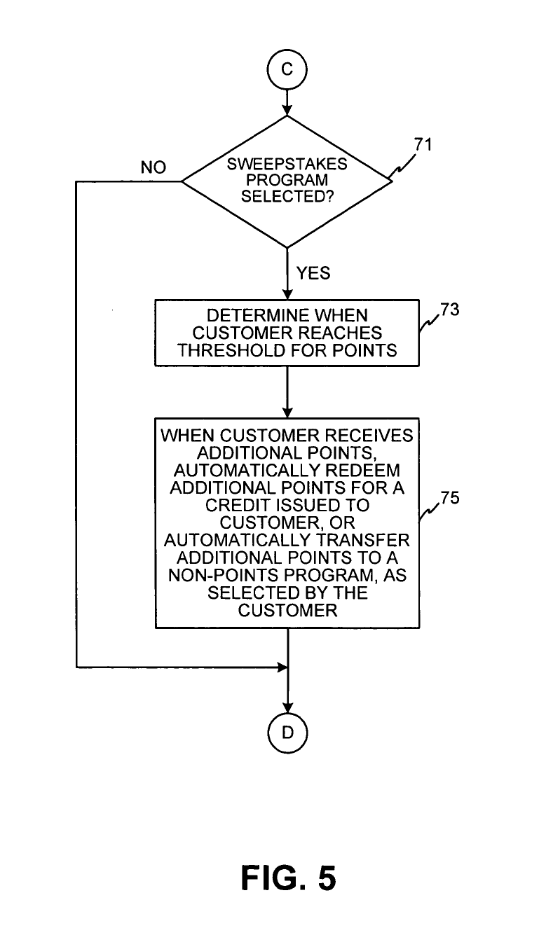

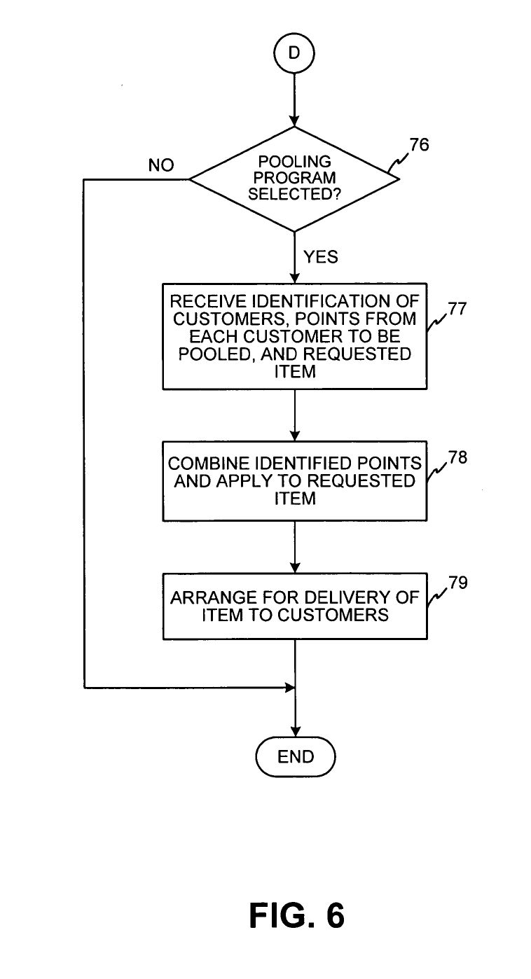

FIGS. 3-6 are flow charts of an exemplary method 50 for redeeming points for items according to various redemption programs. Method 50 can be implemented in, for example, software modules for execution by server computer 14. In method 50, the system receives a customer's request for an item and the amount of loyalty points to redeem the item (step 52). The system can optionally assess a fee or premium for the request.

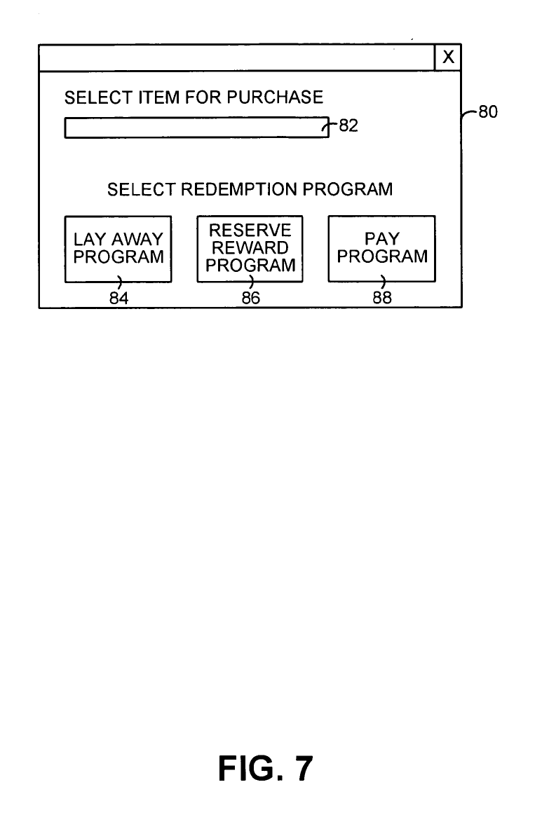

The customer's request may be submitted by customer computer 23, for example, via the Internet or other network. FIG. 7 is a diagram of an exemplary web page or screen 80 for a customer to select a redemption program for an item. In screen 80, a customer can select or identify an item in a section 82. Screen 80 may include, for example, a link to various on-line shopping web sites for a customer to select items for purchase. For a particular program, the customer may select a section 84 for the layaway program, select a section 86 for the reserve reward program, or select a section 88 for the pay program. Other programs are possible as well, depending upon particular implementation of the deferred loyalty point methods.

Any screens or web pages corresponding with the points redemption programs may be hosted by a web site for the customer to access. In this regard, the computers discussed herein may provide a suitable web site, webpage or other Internet-based graphical customer interface which is accessible by customers. In one embodiment, the Internet Information Server, Microsoft Transaction Server, and Microsoft SQL Server, are used in conjunction with the Microsoft operating system, Microsoft NT web server software, a Microsoft SQL database system, and a Microsoft Commerce Server. Additionally, components such as Access or SQL Server, Oracle, Sybase, Informix MySQL, Interbase, etc., may be used to provide an ADO-compliant database management system. The term “webpage” as it is used herein is not meant to limit the type of documents and applications that might be used to interact with the customer. For example, a typical web site might include, in addition to standard HTML documents, various forms, Java applets, Javascript, active server pages (ASP), common gateway interface scripts (CGI), extensible markup language (XML), dynamic HTML, cascading style sheets (CSS), helper applications, plug-ins, and the like. A server may include a webservice which receives a request from a browser which includes a URL (http://yahoo.com/stockquotes/ge) and an IP address (123.56.789). The webservice retrieves the appropriate webpages and sends the webpages to the IP address.

In method 50, the system provides redemption options to the customer such as via screen 80 (step 54), and it receives the customer's selection of a particular redemption program (step 56). Based upon which program the customer selected, the system processes the request using at least a portion of the customer's points. Examples of redemption programs are provided above.

If the customer selected the layaway program (step 58), the system applies a predetermined number of the customer's points to the requested item on a periodic basis and tracks the cumulative total amount of points applied to the item (step 60). The number of points applied to the item in any of the embodiments discussed herein may be established by the customer, merchant, loyalty program, random, a set amount, an escalating amount, a decreasing amount, based on a formula and/or the like. After the item is fully paid for (or any other threshold established by the system), the system arranges for delivery of the item to the customer or any other third party (step 62) via known in the art automated scheduling and delivery systems.

If the customer selected the reserve reward program (step 64), the system applies an initial number of the customer's points to the requested item to reserve a price for it during a particular time frame (step 66). If the customer requests purchase of the item during the time frame, the system processes payment for the item using the reserved price and arranges for delivery of the item to the customer or any other third party via known in the art automated scheduling and delivery systems (step 68).

If the customer selected the pay program (step 70), the system determines a price for the requested item based upon partial payment using points by the customer (step 72). The system processes payment for the item and arranges for delivery of the item to the customer or any other third party via known in the art automated scheduling and delivery systems (step 74).

In the customer selected the sweepstakes program for the automatic transfer or redemption of points (step 71), the system determines when the customer reaches a particular threshold number of loyalty points (step 73). Once that threshold is reached and when the customer receives additional points, those additional points are automatically redeemed for a credit issued to the customer or are automatically transferred to a non-points program, as selected by the customer (step 75). With the sweepstakes program, the threshold for the automatic redemption or transfer of loyalty points may be set at any particular number, possibly selected by the customer, the merchant or provider, or by a default value. The redemption for a credit may result in any particular type of credit for use by the customer for purchase, or partial purchase, of goods or services. For the transfer of points, the non-points program can include any program not using points assigned to a customer; for example, they can include mutual funds or other financial investment instruments.

If the customer request to pool loyalty points with others (step 76), the system receives an identification of the customers who wish to pool loyalty points, a number of points for each of the customers to be pooled, and a requested item by the customers (step 77). The system combines the identified loyalty points and applies them to the requested item (step 78). The system processes the loyalty points for the item and arranges for delivery of the item to the customers or any other third parties via known in the art automated scheduling and delivery systems (step 79). The pooling of points can also involve any of the other programs, layaway, pay, or sweepstakes, with the points involved being an accumulation of multiple customers' loyalty points.

The processing of the programs can access a database storing loyalty points associated with particular customers and can modify the number of stored points according to the parameters of the program. Also, the system can provide periodic reports to the customers, merchants or any other third party, such as, for example via e-mail messages, indicating the processing of the customer's loyalty points and the number of points remaining in the customer's account.

When the loyalty points are used for redemption of an item that also requires a payment, the processing of that payment can make use of a credit card or other financial instrument for providing the remaining balance of payment for the item. Also, in processing payment, the system may make use of an account number for the customer. An “account” or “account number,” as used herein, may include any device, code, number, letter, symbol, digital certificate, smart chip, digital signal, analog signal, biometric or other identifier/indicia suitably configured to allow the customer to access, interact with or communicate with the system such as, for example, one or more of an authorization/access code, personal identification number (PIN), Internet code, other identification code, and/or the like which may optionally be located on or associated with a rewards card, charge card, credit card, debit card, prepaid card, telephone card, smart card, magnetic stripe card, bar code card, transponder, radio frequency card or an associated account. The account number may be distributed and stored in any form of plastic, electronic, magnetic, radio frequency, wireless, audio and/or optical device capable of transmitting or downloading data from itself to a second device. A customer account number may be, for example, a sixteen-digit credit card number, although each credit provider has its own numbering system, such as the fifteen-digit numbering system used by American Express. Each company's credit card numbers comply with that company's standardized format such that the company using a sixteen-digit format will generally use four spaced sets of numbers, as represented by the number “0000 0000 0000 0000”. The first five to seven digits are reserved for processing purposes and identify the issuing bank, card type, etc. In this example, the last (sixteenth) digit is used as a sum check for the sixteen-digit number. The intermediary eight-to-ten digits are used to uniquely identify the customer. A merchant account number may be, for example, any number or alpha-numeric characters that identifies a particular merchant for purposes of card acceptance, account reconciliation, reporting, or the like.

Any databases discussed herein may be any type of database, such as relational, hierarchical, graphical, object-oriented, and/or other database configurations. Common database products that may be used to implement the databases include DB2 by IBM (White Plains, N.Y.), various database products available from Oracle Corporation (Redwood Shores, Calif.), Microsoft Access or Microsoft SQL Server by Microsoft Corporation (Redmond, Wash.), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, and/or the like. The association step may be accomplished by a database merge function, for example, using a “key field” in pre-selected databases or data sectors.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one aspect of the present invention, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); block of binary (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In one exemplary embodiment, the ability to store a wide variety of information in different formats is facilitated by storing the information as a Block of Binary (BLOB). Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store Various data sets that have different formats facilitates the storage of data associated with the financial transaction instrument by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments of the present invention, the data can be stored without regard to a common format. However, in one exemplary embodiment of the present invention, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified merchants are permitted to access the data set for reading, and others are altogether excluded from accessing the data set. However, other access restriction parameters may also be used allowing various entities to access a data set with various permission levels as appropriate.

The data, including the header or trailer may be received by a stand alone interaction device configured to add, delete, modify, or augment the data in accordance with the header or trailer. As such, in one embodiment, the header or trailer is not stored on the transaction device along with the associated issuer-owned data but instead the appropriate action may be taken by providing to the transaction instrument user at the stand alone device, the appropriate option for the action to be taken. The present invention may contemplate a data storage arrangement wherein the header or trailer, or header or trailer history, of the data is stored on the transaction instrument in relation to the appropriate data.

One skilled in the art will also appreciate that, for security reasons, any databases, systems, devices, servers or other components of the present invention may consist of any combination thereof at a single location or at multiple locations, wherein each database or system includes any of various suitable security features, such as firewalls, access codes, encryption, decryption, compression, decompression, and/or the like.

The detailed description of exemplary embodiments of the invention herein makes reference to the accompanying drawings and pictures, which show the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented.

Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all the claims or the invention. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical”.

1-17. (canceled)

18. A method, comprising:
receiving, by a computer system, a first data set in a first format from a first merchant, wherein the first data set indicates items to be made available for purchase using loyalty points;
receiving, by the computer system, a second data set in a second format from a second merchant, wherein the second data set indicates items to be made available for purchase using loyalty points, wherein the first and second data sets contain different information that is stored using different data storage formats;
setting access restriction parameters for the first and second data sets to identify merchants that are permitted to access the first or second data set; and
storing the first and second data set and corresponding access restriction parameters in a hierarchical filing system.

19. The method of claim 18, wherein the hierarchical filing system includes a Block of Binary (BLOB) annotation.

20. The method of claim 19, wherein the BLOB annotation includes a short header, a trailer, or another indicator.

21. The method of claim 19, wherein the BLOB annotation includes information usable to manage the first and second data sets.

22. The method of claim 19, wherein the BLOB annotation includes the access restriction parameters.

23. The method of claim 18, wherein the access restriction parameters include restrictions on individuals able to access the first data set.

24. The method of claim 23, wherein the access restriction parameters further include restrictions on individuals able to access the second data set.

25. The method of claim 23, wherein the access restriction parameters further include restrictions on entities able to access the first data set.

26. An article of manufacture including a non-transitory, computer-readable medium that includes instructions executable by a computing system to carry out steps comprising:
receiving a first data set in a first format from a first merchant, wherein the first data set indicates items to be made available for purchase from the first merchant using loyalty points;
receiving a second data set in a second, different format from a second, different merchant, wherein the second data set indicates items to be made available for purchase from the second merchant using loyalty points;
setting access restriction parameters for the first and second data sets to identify merchants that are permitted to access the first or second data set; and
storing the first and second data set and corresponding access restriction parameters in a hierarchical filing system.

27. The article of claim 26, wherein the hierarchical filing system includes annotations for the first and second data sets, the annotations specifying the access restriction parameters.

28. The article of claim 27, wherein the annotations are in a Block of Binary (BLOB) format.

29. The article of claim 27, wherein the access restriction parameters are usable to establish permissions for accessing, modifying, and deleting the first and second data sets.

30. The article of claim 29, wherein the access restriction parameters further include owners for the first and second data sets, and wherein only the respective owners for the first and second data sets are permitted to delete the first and second data sets.

31. A system, comprising:
at least one processor; and
a memory coupled to the at least one processor that includes instructions executable by the at least one processor to cause the system to carry out operations comprising:
receiving a first data set in a first format from a first merchant, wherein the first data set indicates items to be made available for purchase from the first merchant using loyalty points;
receiving a second data set in a second format from a second merchant, wherein the second data set indicates items to be made available for purchase from the second merchant using loyalty points, wherein the first and second data sets contain different information that is stored using different data storage formats;
setting access restriction parameters for the first and second data sets to identify merchants that are permitted to access the first or second data set; and
storing the first and second data set and corresponding access restriction parameters in a hierarchical filing system.

32. The system of claim 31, wherein the first and second data sets are storable on a financial transaction instrument.

33. The system of claim 32, wherein the financial transaction instrument is a credit card.

34. The system of claim 31, wherein the operations further comprise receiving a third data set from a third merchant, wherein the third data set indicates items to be made available for purchase from the third merchant.

35. The system of claim 34, wherein the third data set is received in a third format.

36. The system of claim 31, wherein the access restriction parameters indicate at least one individual that is unable to access the first data set.

37. The system of claim 36, wherein the at least one individual is further unable to access the second data set.
